(19) United States
(12) Patent Application Publication
(10) Pub. No.: US 2025/0080192 A1
(43) Pub. Date: Mar. 6, 2025

(54) METHOD FOR ESTIMATING BEAM DOMAIN CHANNEL IN SPATIAL NON-STATIONARY MASSIVE MIMO SYSTEM

(71) Applicants: Southeast University, Nanjing (CN); PURPLE MOUNTAIN LABORATORIES, Nanjing (CN)

(72) Inventors: Chengxiang WANG, Nanjing (CN); Lin HOU, Nanjing (CN); Hengtai CHANG, Nanjing (CN); Jie HUANG, Nanjing (CN)

(21) Appl. No.: 18/816,232

(22) Filed: Aug. 27, 2024

(30) Foreign Application Priority Data
Aug. 29, 2023 (CN) 202311091924.2

(51) Int. Cl. H04B 7/06; H04B 7/0413

(52) U.S. Cl. CPC H04B 7/0634; H04B 7/0413

(57) ABSTRACT

A method for estimating a beam domain channel in a spatial non-stationary massive MIMO system includes constructing a beam domain channel model for the spatial non-stationary massive MIMO system by using a visibility region; transforming a problem for estimating the beam domain channel into a problem for reconstructing a sparse channel based on a sparsity of beam domain channel and an influence of power leakage; proposing a beam domain structure-based sparsity adaptive matching pursuit scheme according to a cross-block sparse structure and a power ratio threshold of the beam domain channel; and verifying that the proposed scheme has a lower pilot overhead, a higher accuracy and a higher effectiveness compared to the traditional schemes in simulation results. The method can be effectively applied to communication channel estimation with non-stationary characteristics, and has obvious advantages in estimation accuracy and complexity.

### TECHNICAL FIELD

The present disclosure relates to the technical field of communication channel estimation in wireless communication technology, and especially relates to a method for estimating a beam domain channel in a spatial non-stationary massive multiple-in multiple-output (MIMO) system.

### BACKGROUND

In order to satisfy growing requirements for a communication capacity, a high speed, and a full coverage in the fifth generation (5G) mobile communication system and sixth generation (6G) mobile communication system, massive MIMO plays a key role in improving efficiency of spectrum and energy. It is quite essential to obtain accurate channel state information (CSI) so as to effectively utilize the massive MIMO technology.

Communication channel measurements show that the massive MIMO channels exhibit a spatial non-stationarity and express an inherent sparsity. Therefore, a channel estimation for massive MIMO system can be considered as a problem for sparse signal reconstruction. In order to obtain the CSI in massive MIMO system with low pilot overhead, traditional communication channel estimation schemes based on compressed sensing theory mostly consider the massive MIMO channels as spatial stationary channels with a common sparse structure. However, in fact, spatial non-stationary channels do not exhibit the conventional sparse block structures. Therefore, it is inevitable to lead to a poor estimation performance by simply using a common sparse structure to divide the massive MIMO channels into the conventional sparse block structures. On the other hand, in a case of beam domain channel estimation, if a beam dominant term that forms the beam domain channel matrix is only determined based on a power leakage, ignoring impacts of communication channel spatial non-stationarity on power leakage, resulting in channel estimation deviating from an actual communication channel model and thus causing a distortion on estimation performances. In order to estimate the beam domain channel for the spatial non-stationary massive MIMO system more accurately, it is necessary to propose a novelty method for estimating the communication channel, and the method is capable of being verified its correctness.

### SUMMARY

The technical problems to be solved by the present disclosure is to propose a method for estimating a beam domain channel in a spatial non-stationary massive MIMO system in consideration of more realistic beam domain channel with the spatial non-stationarity and the power leakage, so as to further improve the estimation performance for the communication channel with a lower algorithm complexity.

In order to solve above technical problems, the technical solutions adopted by the present disclosure are as follows.

Provided is a method for estimating a beam domain channel in a spatial non-stationary massive MIMO system. And the method includes the following steps.

In Step S1, a beam domain channel model for the spatial non-stationary massive MIMO system is constructed.

In Step S2, a beam sparse structure is obtained according to the beam domain channel model and a power ratio threshold is obtained according to an influence of power leakage. A problem for estimating the beam domain channel is transformed into a problem for reconstructing a sparse communication channel.

In Step S3, a dominant beam support is obtained based on the beam sparse structure, and the dominant beam support is refined according to the power radio threshold. A beam support set is obtained by adopting beam domain structure-based sparsity adaptive matching pursuit (BDS-SAMP) scheme. A beam domain channel vector for a single user is reconstructed according to the beam support set, and an estimating channel matrix is obtained.

Further, the steps of Step S1 are specifically as follows.

In Step S101, all base stations in the spatial non-stationary massive MIMO system are equipped with a uniform planar array (UPA) of P=Pₕ×Pᵥ, where Pₕ and Pᵥ denote an antenna number of horizontal dimension and an antenna number of vertical dimension of the UPA, respectively. The base stations serve U single antenna users, and all the scattering clusters are divided into wholly visible (WV) clusters and partially visible (PV) clusters. Each cluster has a corresponding visibility region (VR). The VR of WV clusters is the entire array, while that of PV clusters is the partial array. A ratio of PV clusters to total clusters is ρ.

In Step S102, a geometry-based stochastic channel model (GBSM) is constructed, and an array domain channel matrix Hᵤ of a u-th user is denoted as

$${H}_{u} = {\sum }_{n ∈ {N}_{1}} {\sum }_{m = 1}^{{M}_{n}} {β}_{n , m} {e}^{j ( - 2 π f {τ}_{n , m} + {Φ}_{n , m} )} U ( {θ}_{n , m}^{az} , {θ}_{n , m}^{el} ) + {\sum }_{n ∈ {N}_{2}} {\sum }_{m = 1}^{{M}_{n}} {β}_{n , m} {e}^{j ( - 2 π f {τ}_{n , m} + {Φ}_{n , m} )} \hat{U} ( {θ}_{n , m}^{az} , {θ}_{n , m}^{el} )$$

where N₁ and N₂ denote sets of the WV clusters and PV clusters, respectively. Mₙ denotes the total number of rays in the scattering clusters, f denotes a carrier frequency, β_{n,m}, τ_{n,m} and Φ_{n,m} denote a coefficient, a delay, and an initial phase of the m-th ray in the n-th scattering cluster, respectively. A UPA steering matrix for WV clusters is defined as U(θ_{n,m}^{az}, θ_{n,m}^{el}). Û(θ_{n,m}^{az}, θ_{n,m}^{el}) denotes the UPA steering matrix for PV clusters with Û(θ_{n,m}^{az}, θ_{n,m}^{el})=U(θ_{n,m}^{az}, θ_{n,m}^{el}) ⊙ξ_{n,m}, where ⊙ denotes a Hadamard product, and ξ_{n,m} denotes the VR of the m-th path consisting only of 0 and 1.

In Step S103, the beam domain channel model for the spatial non-stationary massive MIMO system is constructed. The array domain channel matrix is transformed into a beam domain channel matrix through a two-dimensional DFT processing as follows

H_{B,u}=Fₑₗ*HᵤF_{az}^{T},

where {●}* denotes a complex conjugate operation, {●}^{T} denotes a transpose operation, and Fₑₗ and F_{az} denote an elevation beamforming matrix and an azimuth beamforming matrix, respectively.

Further, the beam sparse structure is a beam cross-block sparse structure, and the influence of power leakage includes two situations.

In a case where a ratio ρ of PV clusters to total clusters is 0, an imperfect beam sampling leads to a power leakage.

In a case where the ratio ρ of PV clusters to total clusters is not 0, the power leakage can be observed inevitably due to a partial visibility of VR resulting lower spatial resolution for non-stationary channel.

Further, the problem for reconstructing the sparse channel is described as follows.

In the non-stationary massive MIMO system, an orthogonal pilot sequence is transmitted repeatedly for Q times by the base station to U users and a pilot matrix is obtained according to the orthogonal pilot sequence transmitted by the base station to the users. The communication channel experiences the same fading during a time slot K=U×Q, and an analog precoder F_{q}∈ [symbol] ^{U×P} is adopted in the base station, in a case of transmitting the q-th pilot sequence, a received signal y_{u,q} of the u-th user is denoted as:

$${y}_{u , q} = {Φ}_{q} {H}_{B , u} + {\tilde{n}}_{u , q} ,$$

where Φ_{q}=F_{q}(Fₑₗ⊗F_{az})^{H}, ⊗ denotes a Kronecker product, ñ_{u,q}˜CN(0, σ²I_{U}) denotes an additive white Gaussian noise vector, σ² denotes a noise power, after repeatedly transmitting the pilot sequence for Q times, a received signal matrix of the u-th user is

$${y}_{u} = Φ {H}_{B , u} + {\tilde{n}}_{u} ,$$

where yᵤ [symbol] [y_{u,1}^{T}, y_{u,2}^{T}, . . . , y_{u,Q}^{T}]^{T}, and Φ [symbol] [Φ₁^{T}, Φ₂^{T}, . . . , Φ_{Q}^{T}]^{T} ∈ [symbol] ^{K×P} denotes a measurement matrix, and ñᵤ [symbol] [ñ_{u,1}^{T}, ñ_{u,2}^{T}, . . . , ñ_{u,q}^{T}]∈ [symbol] ^{K×1} denotes a noise matrix.

Further, the BDS-SAMP scheme specifically includes the following steps.

A received signal yᵤ, a measurement matrix Φ, a power ratio threshold μ, and a step size s are inputted.

An estimated beam domain channel matrix Ĥ_{B,u} is outputted.
(a) Initialization: an initial residual vector is r₀=yᵤ, a beam support set is Ωₛ=∅, the number of iterations is k=1, and a step size is s=1.
(b) A column

$${S}_{k} = max \{ {\vert {Φ}_{p}^{H} {r}_{k - 1} \vert}_{p = 1}^{P} , s \}$$

that is most relevant to the residual vector is found according to a residual vector rₖ₋₁ of the k−1-th iteration and the p-th column Φₚ of the measurement matrix Φ, to obtain an initial dominant beam support.
(c) A dominant beam support at a top part of Sₖ, a dominant beam support at a bottom part of Sₖ, a dominant beam support at a left part of Sₖ, and a dominant beam support at a right part of Sₖ are locked according to the beam cross-block structure, and a power ratio \tilde{μ} of each of the dominant beam supports to an entire dominant beam support is calculated in sequence.
(d) The power ratio \tilde{μ} is compared with the power ratio threshold μ, and a dominant beam support set is refined and updated.
(e) It is let that Cₖ=Ωₛ ∪Sₖ and a beam indices set is obtained by merging Ωₛ and Ωₛ.
(f) It is let that

$$F = max \{ {\vert {( {Φ}_{p}^{H} {Φ}_{p} )}^{- 1} {Φ}_{p}^{H} {y}_{u} \vert}_{p = 1}^{card ( {C}_{k} )} , s \} ,$$

and a least squares (LS) estimated value for a communication channel H_{B,u} of the spatial non-stationary massive MIMO system is obtained by Ĥ_{B,u}[F]=(Φ_{F}^{H}Φ_{F})⁻¹Φ_{F}^{H}yᵤ, where F denotes a final beam indices set for a single iteration, card (Cₖ) denotes the number of elements in Cₖ, and Φ_{F} denotes a corresponding column of the obtained measurement matrix.
(g) A residual r_{F}=yᵤ−Φ_{F}Ĥ_{B,u}[F] is updated.
(h) In a case where the residual vector satisfies r_{F}. . . rₖ₋₁, a step s=s+1 is updated and Step (b) is returned to for continuing the iteration. In a case where the residual vector satisfies ∥r_{F}∥₂²<∥yᵤ∥₂²/(10^{SNR/10}+1), where SNR denotes a signal-to-noise ratio, it is let that Ωₛ=F, and rₖ=r_{F}, and the iteration is terminated and Step (i) is entered. In a case where neither of the above two are satisfied, it is let that ΩₛF, rₖ=r_{F}, and k=k+1, and the iteration is stopped when k . . . K, and Step (i) is entered.
(i) An estimated value for the beam domain channel is obtained by Ĥ_{B,u}[Ωₛ]=(Φ_{Ω}_{ₛ}^{H}Φ_{Ω}_{ₛ})⁻¹Φ_{Ω}_{ₛ}^{H}yᵤ.

Further, the measurement matrix Φ is a Bernoulli random matrix, elements in Φ are randomly selected from a set

$$\frac{1}{\sqrt{K}} \{ - 1 , 1 \}$$

with an equal probability and satisfy a requirement of a relative little column interference

$$μ = {max}_{i \neq j} \vert {Φ}_{i}^{H} {Φ}_{j} \vert ,$$

and Φᵢ and Φⱼ denote different columns of the measurement matrix Φ.

The beneficial effects of the present disclosure are as follows. In view of the more realistic beam domain channels, considering the influences of the spatial non-stationarity and the power leakage, a method for estimating a beam domain channel in a spatial non-stationary massive MIMO system is proposed, to implement the more effective communication channel estimation on the massive MIMO system at the lower algorithm complexity.

### BRIEF DESCRIPTION OF THE DRAWINGS

FIG. 1 illustrates a flow chart diagram of constructing a beam domain channel model for the spatial non-stationary massive MIMO system in the present disclosure.

FIG. 2 illustrates a structural diagram of a massive MIMO system based on UPA.

FIG. 3 illustrates a schematic diagram of a sparse structure of a massive MIMO beam domain channel in the present disclosure.

FIG. 4 illustrates a comparison result diagram of the normalized mean square error (NMSE) performance of different channel estimation schemes for spatial non-stationary massive MIMO system in the embodiments of the present disclosure.

FIG. 5 illustrates a comparison result diagram of a NMSE performance of different channel estimation schemes for spatial stationary massive MIMO system in the embodiments of the present disclosure.

FIG. 6 illustrates a comparison result diagram of a NMSE performance of a beam domain structure-based sparsity adaptive matching pursuit scheme under different antenna numbers in the embodiments of the present disclosure.

### DETAILED DESCRIPTION OF THE EMBODIMENTS

In order to clarify the objectives, the technical solutions, and the advantages of the embodiments of the present disclosure, the technical solutions in the embodiments of present disclosure will be clearly and completely described in conjunction with the accompanying drawings. Obviously, the described embodiments are one part of the embodiments of the present disclosure, not all of them. Based on the embodiments in the present disclosure, all other embodiments obtained by a person skilled in the art without creative labor fall within the protection scope of the present disclosure.

### Embodiment 1

Provided in this embodiment is a method for estimating a beam domain channel in a spatial non-stationary massive MIMO system. The method specifically includes the following steps.

In Step S1, a beam domain channel model for the spatial non-stationary massive MIMO system is constructed.

In Step S2, a beam sparse structure is obtained according to the beam domain channel model and a power ratio threshold is obtained according to an influence of power leakage. A problem for estimating the beam domain channel is transformed into a problem for reconstructing a sparse communication channel.

In Step S3, a dominant beam support is obtained based on the beam sparse structure, and the dominant beam support is refined according to the power radio threshold. A beam support set is obtained by adopting a beam domain channel estimation method for spatial non-stationary massive MIMO system scheme. A beam domain communication channel vector for a single user is reconstructed according to the beam support set, and an estimating channel matrix is obtained.

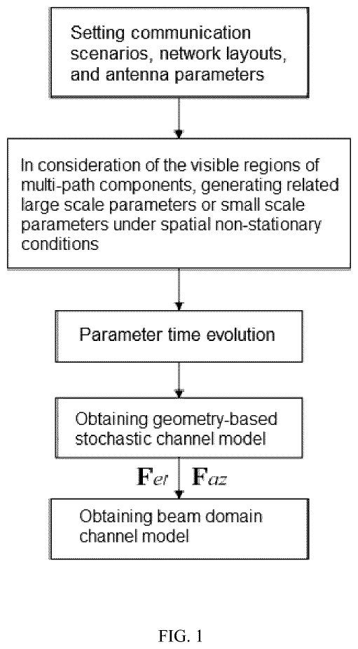

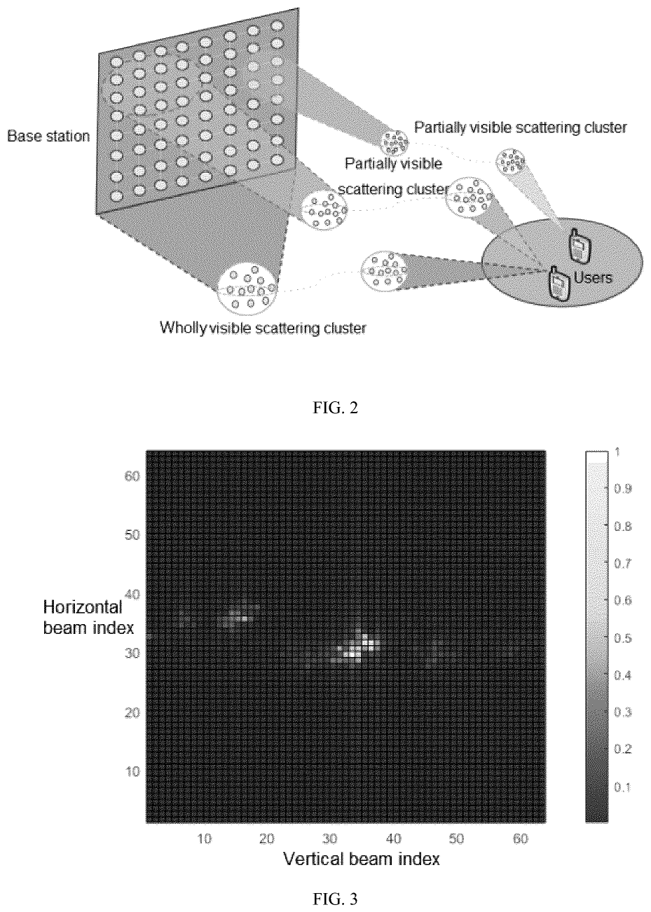

More specifically, in this embodiment, with reference to FIG. 1, Step S1 of the present disclosure are specifically as follows.

In Step S101, all base stations in the spatial non-stationary massive MIMO system are equipped with a uniform planar array (UPA) of P=Pₕ×Pᵥ, where Pₕ and Pᵥ denote an antenna number of horizontal dimension and an antenna number of vertical dimension of the UPA, respectively. The base stations serve U single antenna users, and all the scattering clusters are divided into wholly visible (WV) clusters and partially visible (PV) clusters. Each cluster has a corresponding visibility region (VR). The VR of WV clusters is the entire array, while that of PV clusters is the partial array. A ratio of PV clusters to total clusters is ρ.

In Step S102, a geometry-based stochastic channel model (GBSM) is constructed, and an array domain channel matrix Hᵤ of a u-th user is denoted as

$${H}_{u} = {\sum }_{n ∈ {N}_{1}} {\sum }_{m = 1}^{{M}_{n}} {β}_{n , m} {e}^{j ( - 2 π f {τ}_{n , m} + {Φ}_{n , m} )} U ( {θ}_{n , m}^{az} , {θ}_{n , m}^{el} ) + {\sum }_{n ∈ {N}_{2}} {\sum }_{m = 1}^{{M}_{n}} {β}_{n , m} {e}^{j ( - 2 π f {τ}_{n , m} + {Φ}_{n , m} )} \hat{U} ( {θ}_{n , m}^{az} , {θ}_{n , m}^{el} )$$

where N₁ and N₂ denote sets of the WV clusters and PV clusters, respectively. Mₙ denotes the total number of rays in the scattering clusters, f denotes a carrier frequency, β_{n,m}, τ_{n,m} and Φ_{n,m} denote a coefficient, a delay, and an initial phase of the m-th ray in the n-th scattering cluster, respectively. A UPA steering matrix for WV clusters is defined as U(θ_{n,m}^{az}, θ_{n,m}^{el}). Û(θ_{n,m}^{az}, θ_{n,m}^{el}) denotes the UPA steering matrix for PV clusters with Û(θ_{n,m}^{az}, θ_{n,m}^{el})=U(θ_{n,m}^{az}, θ_{n,m}^{el}) ⊙ξ_{n,m}, where ⊙ denotes a Hadamard product, and ξ_{n,m} denotes the VR of the m-th path consisting only of 0 and 1.

In Step S103, the beam domain channel model for the spatial non-stationary massive MIMO system is constructed. The array domain channel matrix is transformed into a beam domain channel matrix through a two-dimensional DFT processing as follows

H_{B,u}=Fₑₗ*HᵤF_{az}^{T},

where {●}* denotes a complex conjugate operation, {●}^{T} denotes a transpose operation, and Fₑₗ and F_{az} denote an elevation beamforming matrix and an azimuth beamforming matrix, respectively.

In this embodiment, as illustrated in FIG. 3, the beam sparse structure is a beam cross-block structure, and the influence of power leakage includes two situations.
(1) In a case where the ratio ρ of PV clusters to total clusters is 0, an imperfect beam sampling leads to a power leakage.
(2) In a case where the ratio ρ of PV clusters to total clusters is not 0, the power leakage can be observed inevitably due to a partial visibility of VR resulting lower spatial resolution for non-stationary channel.

Specifically, in this embodiment, the problem for reconstructing the sparse channel is described as follows.

In the non-stationary massive MIMO system, an orthogonal pilot sequence is transmitted repeatedly for Q times by the base station to U users and a pilot matrix is obtained according to the orthogonal pilot sequence transmitted by the base station to the users. The communication channel experiences the same fading during a time slot K=U×Q, and an analog precoder F_{q}∈ [symbol] ^{U×P} is adopted in the base station, in a case of transmitting the q-th pilot sequence, and a received signal y_{u,q} of the u-th user is denoted as:

$${y}_{u , q} = {Φ}_{q} {H}_{B , u} + {\tilde{n}}_{u , q} ,$$

where Φ_{q}=F_{q}(Fₑₗ⊗F_{az})^{H}, ⊗ denotes a Kronecker product, ñ_{u,q}˜CN(0, σ²I_{U}) denotes an additive white Gaussian noise vector, σ² denotes a noise power, after repeatedly transmitting the pilot sequence for Q times, a received signal matrix of the u-th user is

$${y}_{u} = Φ {H}_{B , u} + {\tilde{n}}_{u} ,$$

where yᵤ [symbol] [y_{u,1}^{T}, y_{u,2}^{T}, . . . , y_{u,Q}^{T}]^{T}, and Φ [symbol] [Φ₁^{T}, Φ₂^{T}, . . . , Φ_{Q}^{T}]^{T} ∈ [symbol] ^{K×P} denotes a measurement matrix, and ñᵤ [symbol] [ñ_{u,1}^{T}, ñ_{u,2}^{T}, . . . , ñ_{u,q}^{T}]∈ [symbol] ^{K×1} denotes a noise matrix.

Specifically, the BDS-SAMP scheme specifically includes the following steps.

A received signal yᵤ, a measurement matrix Φ, a power ratio threshold μ, and a step size s are inputted.

An estimated beam domain channel matrix Ĥ_{B,u} is outputted.
(a) Initialization: an initial residual vector is r₀=yᵤ, a beam support set is Ωₛ=∅, the number of iterations is k=1, and a step size is s=1.
(b) A column

$${S}_{k} = max \{ {\vert {Φ}_{p}^{H} {r}_{k - 1} \vert}_{p = 1}^{P} , s \}$$

that is most relevant to the residual vector is found according to a residual vector rₖ₋₁ of the k−1-th iteration and the p-th column Φₚ of the measurement matrix Φ, to obtain an initial dominant beam support.
(c) A dominant beam support at a top part of Sₖ, a dominant beam support at a bottom part of Sₖ, a dominant beam support at a left part of Sₖ, and a dominant beam support at a right part of Sₖ are locked according to the beam cross-block structure, and a power ratio \tilde{μ} of each of the dominant beam supports to an entire dominant beam supports is calculated in sequence.
(d) The power ratio \tilde{μ} is compared with the power ratio threshold μ, and a dominant beam support set is refined and updated.
(e) It is let that Cₖ=Ωₛ ∪Sₖ and a beam indices set is obtained by merging Ωₛ and Ωₛ.
(f) It is let that

$$F = max \{ {\vert {( {Φ}_{p}^{H} {Φ}_{p} )}^{- 1} {Φ}_{p}^{H} {y}_{u} \vert}_{p = 1}^{card ( {C}_{k} )} , s \} ,$$

and a least squares (LS) estimated value for a communication channel H_{B,u} of the spatial non-stationary massive MIMO system is obtained by Ĥ_{B,u}[F]=(Φ_{F}^{H}Φ_{F})⁻¹Φ_{F}^{H}yᵤ, where F denotes a final beam indices set for a single iteration, card(Cₖ) denotes the number of elements in Cₖ, and Φ_{F} denotes a corresponding column of the obtained measurement matrix.
(g) A residual r_{F}=yᵤ−Φ_{F}Ĥ_{B,u}[F] is updated.
(h) In a case where the residual vector satisfies r_{F}. . . rₖ₋₁, a step s=s+1 is updated and Step (b) is returned to for continuing the iteration. In a case where the residual vector satisfies ∥r_{F}∥₂²<∥yᵤ∥₂²/(10^{SNR/10}+1), where SNR denotes a signal-to-noise ratio, it is let that Ωₛ=F, and rₖ=r_{F}, and the iteration is terminated and Step (i) is entered. In a case where neither of the above two are satisfied, it is let that ΩₛF, rₖ=r_{F}, and k=k+1, and the iteration is stopped when k . . . K, and Step (i) is entered.
(i) An estimated value for the beam domain channel is obtained by Ĥ_{B,u}[Ωₛ]=(Φ_{Ω}_{ₛ}^{H}Φ_{Ω}_{ₛ})⁻¹Φ_{Ω}_{ₛ}^{H}yᵤ.

Specifically, the measurement matrix Φ is a Bernoulli random matrix, elements in Φ are randomly selected from a set

$$\frac{1}{\sqrt{K}} \{ - 1 , 1 \}$$

with an equal provaviny and satisfy a requirement of a relative little column interference

$$μ = {max}_{i \neq j} \vert {Φ}_{i}^{H} {Φ}_{j} \vert ,$$

and Φᵢ and Φⱼ denote different columns of the measurement matrix Φ.

In order to verify the beam domain channel estimation method for spatial non-stationary massive MIMO system provided in this embodiment, especially to verify the performance of the BDS-SAMP scheme, the estimation accuracy of the scheme is measured by using the

$$\text{?} MSE = E \{ \frac{{‖ {H}_{B , u} - {\hat{H}}_{B , u} ‖}_{2}^{2}}{{‖ {H}_{B , u} ‖}_{2}^{2}} \} .$$

$$\text{?} \text{indicates text missing or illegible when filed}$$

When constructing the model for beam domain channel of spatial non-stationary massive MIMO system, the carrier frequency is set to 11 GHZ, and other communication channel parameters are set according to the urban microcellular communication scenario in 3GPP.

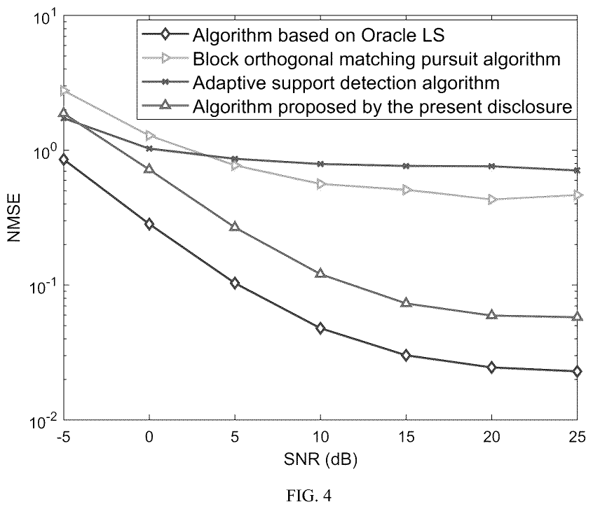

FIG. 4 illustrates the comparison results of the NMSE performance in view of different channel estimation schemes of spatial non-stationary massive MIMO system under different SNR conditions when Pₕ=32, Pᵥ=32, K=256, and ρ=0.45. The compared estimation schemes are the algorithm based on the Oracle LS, the block orthogonal matching pursuit (BOMP) algorithm, and the adaptive support detection (ASD) algorithm. For the algorithm based on the Oracle LS, it is assumed that the users know the total sparsity of the communication channels and can directly choose the dominant beam support according to the sparsity, which is an ideal estimation and can be seen as the upper bound of the estimation performance. It can be seen that compared with the BOMP and ASD, the BDS-SAMP scheme proposed in the present disclosure can significantly improve the accuracy of NMSE estimation, especially in the high SNR regions. In addition, since the number of pilots K is much less than the dimension P of the beam domain channels, the scheme has a lower pilot overhead.

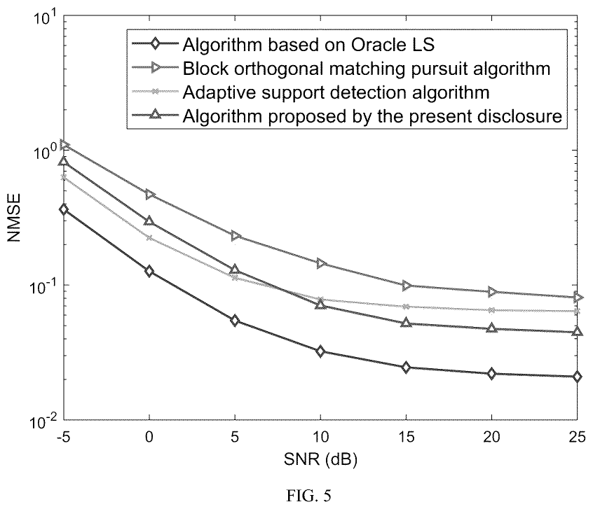

FIG. 5 illustrates the comparison results of the NMSE performance in view of different channel estimation schemes in a spatial stationary massive MIMO system under different SNR conditions when Pₕ=32, Pᵥ=32, K=256, and ρ=0, which is used to test the beam domain channel estimation performance for the BDS-SAMP scheme proposed in the present disclosure in the spatial stationary massive MIMO system. The estimation performance of the spatial stationary channels is commonly superior to that of the spatial non-stationary channels, but this comes at the cost of sacrificing the communication channel authenticity. In this case, the BDS-SAMP scheme proposed in the present disclosure is superior to the BOMP algorithm and the ASD algorithm in NMSE estimation accuracy, especially in high SNR regions. Moreover, the performance of the BDS-SAMP scheme proposed in the present disclosure is similar to that of the ASD algorithm in low SNR regions.

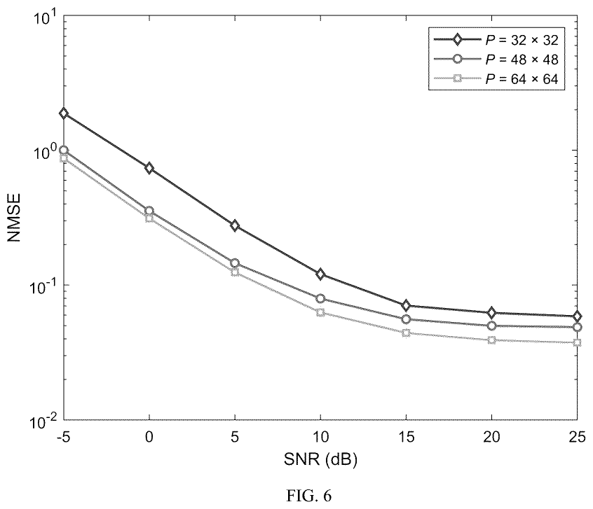

FIG. 6 illustrates the comparison result of the NMSE performance of the BDS-SAMP scheme under different antenna numbers, with the antenna numbers of 32×32, 48×48, and 64×6, respectively, and the pilot numbers K=P/4. The results indicate that in the low SNR regions and the high SNR regions, the NMSE performance improves with an increase in the number of antennas. Therefore, the BDS-SAMP scheme proposed in the present disclosure can accurately estimate the communication channel of the spatial non-stationary massive MIMO system.

The present disclosure proposes a beam domain channel estimation method for spatial non-stationary massive MIMO system. Compared with the existing communication channel estimation methods, the method proposed by the present disclosure considers the non-stationary and power leakage of massive MIMO channels, and compares the results with different estimation schemes, which verifies the accuracy and the effectiveness of BDS-SAMP scheme proposed by the present disclosure compared with the traditional estimation schemes. The method for estimating the beam domain channel in spatial non-stationary massive MIMO system provided by the present disclosure can be effectively applied to the communication channel estimation with non-stationary characteristics, and has obvious advantages in estimation accuracy and complexity.

The unspecified parts in the present disclosure are all the common sense for a person skilled in the art.

The preferred specific embodiments of the present disclosure are described in details in above. It should be understood that various amendments and changes can be made by an ordinary person skilled in the art according to the concept of the present disclosure with no creative efforts. Therefore, all technical solutions that can be obtained by a person skilled in the art on a basis of the prior art according to the concept of the present disclosure through the logical analysis, reasoning, or limited experiments should be within the protection scope determined by the claims.

What is claimed is:

1. A method for estimating a beam domain channel in a spatial non-stationary massive MIMO system, wherein the method comprises following steps:
Step S1, constructing a beam domain channel model for the spatial non-stationary massive MIMO system;
Step S2, obtaining, according to the beam domain channel model, a beam sparse structure, obtaining, according to an influence of power leakage, a power ratio threshold, and transforming, a problem for estimating the beam domain channel into a problem for reconstructing a sparse communication channel; and
Step S3, obtaining, based on the beam sparse structure, a dominant beam support, refining, according to the power radio threshold, the dominant beam support, obtaining, by adopting a beam domain structure-based sparsity adaptive matching pursuit (BDS-SAMP) scheme, a beam support set, sequentially reconstructing, according to the beam support set, a beam domain channel vector for a single user, and obtaining an estimating communication channel matrix.

2. The method for estimating the beam domain channel in the spatial non-stationary massive MIMO system according to claim 1, wherein steps of Step S1 are specifically:
Step S101, constructing the spatial non-stationary massive MIMO system, wherein all base stations in the spatial non-stationary massive MIMO system are equipped with a uniform planar array (UPA) of P=Pₕ×Pᵥ, where Pₕ and Pᵥ denote an antenna number of horizontal dimension and an antenna number of vertical dimension of the UPA, respectively; the base stations serve U single antenna users, and all the scattering clusters are divided into wholly visible (WV) clusters and partially visible (PV) clusters; each cluster has a corresponding visibility region (VR); the VR of WV clusters is the entire array, while that of PV clusters is the partial array; and a ratio of PV clusters to total clusters is ρ;
Step S102, constructing a geometry-based stochastic channel model (GBSM), and denoting an array domain channel matrix Hᵤ of a u-th user as
$${H}_{u} = {\sum }_{n ∈ {N}_{1}} {\sum }_{m = 1}^{{M}_{n}} {β}_{n , m} {e}^{j ( - 2 π f {τ}_{n , m} + {Φ}_{n , m} )} U ( {θ}_{n , m}^{az} , {θ}_{n , m}^{el} ) + {\sum }_{n ∈ {N}_{2}} {\sum }_{m = 1}^{{M}_{n}} {β}_{n , m} {e}^{j ( - 2 π f {τ}_{n , m} + {Φ}_{n , m} )} \hat{U} ( {θ}_{n , m}^{az} , {θ}_{n , m}^{el} ) ,$$
where N₁ and N₂ denote sets of the WV clusters and PV clusters, respectively, Mₙ denotes a total number of rays in the scattering clusters, f denotes a carrier frequency, β_{n,m}, τ_{n,m} and Φ_{n,m} denote a coefficient, a delay, and an initial phase of the m-th ray in the n-th scattering cluster, respectively, a UPA steering matrix for WV clusters is defined as U(θ_{n,m}^{az}, θ_{n,m}^{el}), Û(θ_{n,m}^{az}, θ_{n,m}^{el}) denotes the UPA steering matrix for PV clusters with Û(θ_{n,m}^{az}, θ_{n,m}^{el})=U(θ_{n,m}^{az}, θ_{n,m}^{el})⊙ξ_{n,m}, where ⊙denotes a Hadamard product, and ξ_{n,m} denotes the VR of m-th path consisting only of 0 and 1;
Step S103, constructing the beam domain channel model for the spatial non-stationary massive MIMO system; transforming, through a two-dimensional DFT processing, the array domain channel matrix into a beam domain channel matrix:
H_{B,u}Fₑₗ*HᵤF_{az}^{T},
where {●}* denotes a complex conjugate operation, {●}^{T} denotes a transpose operation, and Fₑₗ and F_{az} denote an elevation beamforming matrix and an azimuth beamforming matrix, respectively.

3. The method for estimating the beam domain channel in the spatial non-stationary massive MIMO system according to claim 1, wherein the beam sparse structure is a beam cross-block structure, and the influence of power leakage includes two situations:
in a case where the ratio ρ of PV clusters to total clusters is 0, an imperfect beam sampling leads to the power leakage; and
in a case where the ratio ρ of PV clusters to total clusters is not 0, the power leakage can be observed inevitably due to the partial visibility of VR resulting lower spatial resolution for non-stationary channel.

4. The method for estimating the beam domain channel in the spatial non-stationary massive MIMO system according to claim 2, wherein the problem for reconstructing the sparse communication channel is described as:
in the non-stationary massive MIMO system, repeatedly transmitting, by the base station, an orthogonal pilot sequence to U users for Q times, obtaining, according to the orthogonal pilot sequence transmitted by the base station to the users, a pilot matrix, experiencing a same fading during a time slot K=U×Q by the communication channel, adopting an analog precoder F_{q}∈ [symbol] ^{U×P} in the base station, and denoting, in a case of transmitting a q-th pilot sequence, a received signal y_{u,q} of a u-th user as:
$${y}_{u , q} = {Φ}_{q} {H}_{B , u} + {\tilde{n}}_{u , q} ,$$
where Φ_{q}=F_{q}(Fₑₗ⊗F_{az})^{H}, ⊗ denotes a Kronecker product, ñ_{u,q} denotes an additive white Gaussian noise vector, after repeatedly transmitting the pilot sequence for Q times, a received signal matrix of the u-th user is
$${y}_{u} = Φ {H}_{B , u} + {\tilde{n}}_{u} ,$$
where yᵤ [symbol] [y_{u,1}^{T}, y_{u,2}^{T}, . . . , y_{u,Q}^{T}]^{T}, and Φ [symbol] [Φ₁^{T}, Φ₂^{T}, . . . , Φ_{Q}^{T}]^{T} ∈ [symbol] ^{K×P} denotes a measurement matrix, and ñᵤ [symbol] [ñ_{u,1}^{T}, n_{u,2}^{T}, . . . , ñ_{u,Q}^{T}]∈ [symbol] ^{K×1} denotes a noise matrix.

5. The method for estimating the beam domain channel in the spatial non-stationary massive MIMO system according to claim 4, wherein the BDS-SAMP scheme specifically includes following steps:
inputting a received signal yᵤ, a measurement matrix Φ, a power ratio threshold μ, and a step size s;
outputting an estimated beam domain channel matrix Ĥ_{B,u},
(a) an initial residual vector being r₀=yᵤ, a beam support set being Ωₛ=Ø, a number of iterations being k=1, and a step size being s=1;
(b) finding, according to a residual vector rₖ₋₁ of a k−1-th iteration and a p-th column Φₚ of the measurement matrix Φ, a column
$${S}_{k} = max \{ {\vert {Φ}_{p}^{H} {r}_{k - 1} \vert}_{p = 1}^{P} , s \}$$
that is most relevant to the residual vector, to obtain an initial dominant beam support;
(c) locking, according to the beam cross-block structure, a dominant beam support at a top part of Sₖ, a dominant beam support at a bottom part of Sₖ, a dominant beam support at a left part of Sₖ, and a dominant beam support at a right part of Sₖ, and calculating a power ratio of each of the dominant beam supports to an entire dominant beam support in sequence;
(d) comparing the power ratio \tilde{μ} with the power ratio threshold μ, and refining and updating a dominant beam support set;
(e) letting CₖΩₛ∪Sₖ, and obtaining, by merging Ωₛ and Ωₛ, a beam indices set Cₖ;
(f) letting
$$F = max \{ {\vert {( {Φ}_{p}^{H} {Φ}_{p} )}^{- 1} {Φ}_{p}^{H} {y}_{u} \vert}_{p = 1}^{card ( {C}_{k} )} , s \} ,$$
and obtaining, by Ĥ_{B,u}[F] =(Φ_{F}^{H}Φ_{F})⁻¹Φ_{F}^{H}yᵤ, a least squares (LS) estimated value for a communication channel H_{B,u} of the spatial non-stationary massive MIMO system, where F denotes a final beam indices set for a single iteration, card(Cₖ) denotes a number of elements in Cₖ, and Φ_{F} denotes a corresponding column of the obtained measurement matrix;
(g) updating a residual r_{F}=yᵤ−Φ_{F}Ĥ_{B,u}[F];
(h) updating, in a case where the residual vector satisfies r_{F}. . . rₖ₋₁, a step s=s+1, and returning to Step (b) to continue the iteration; letting, in a case where the residual vector satisfies ∥r_{F}∥₂²<∥yᵤ∥₂²/(10^{SNR/10}+1), Ωₛ=F and rₖ=r_{F}, where SNR denotes a signal-to-noise ratio, terminating the iteration and entering Step (i); letting, in a case where neither of above two are satisfied, Ωₛ=F, rₖ=r_{F}, and k=k+1; stopping, when k . . . K, the iteration, and proceeding to Step (i); and
(i) obtaining, by Ĥ_{B,u}[Ωₛ]=(Φ_{Ω}_{ₛ}^{H}Φ_{Ω}_{ₛ})⁻¹Φ_{Ω}_{ₛ}^{H}yᵤ, an estimated value for the beam domain channel.

6. The method for estimating the beam domain channel in the spatial non-stationary massive MIMO system according to claim 5, wherein the measurement matrix Φ is a Bernoulli random matrix, elements in Φ are randomly selected from a set
$$\frac{1}{\sqrt{K}} \{ - 1 , 1 \}$$
with an equal probability and satisfy a requirement of a relative little column mutual interference
$$μ = {max}_{i \neq j} \vert {Φ}_{i}^{H} {Φ}_{j} \vert ,$$
and Φᵢ and Φⱼ denote different columns of the measurement matrix Φ.
